(19) United States
(12) Patent Application Publication
(10) Pub. No.: US 2017/0313296 A1
(43) Pub. Date: Nov. 2, 2017

(54) BRAKE FLUID FEEDING DEVICE

(71) Applicant: Chuan Jiing Enterprise Co., Ltd., Taichung City (TW)

(72) Inventor: Tien Tsai Tseng, Taichung City (TW)

(21) Appl. No.: 15/141,134

(22) Filed: Apr. 28, 2016

(51) Int. Cl. B60T 17/22; F04B 19/22; F04B 15/02; F04B 23/02; F04B 9/14

(52) U.S. Cl. CPC B60T 17/222; F04B 23/028; F04B 9/14; F04B 15/02; F04B 19/22

(57) ABSTRACT

A brake fluid feeding device includes a fluid container, a cap, and an inflator. The cap is assembled on the fluid container. The cap has a first hole and a second hole opened thereon. A gas inlet hose is connected to the first hole and extending outward. A fluid-supplying hose is connected to the second hole. The inflator has a gas-supplying portion for gas output. One end of the gas inlet hose is detachably connected to the gas-supplying portion. When the gas inlet hose is connected to the gas-supplying portion, the gas output from the gas-supplying portion enters into the fluid container via the gas inlet hose. Accordingly, the brake fluid feeding device has a simple structure and can be operated conveniently.

### BACKGROUND OF THE INVENTION

### Field of the Invention

The present invention relates to a fluid feeding device, in particular to a brake fluid feeding device.

### Description of the Prior Art

To exchange the brake fluid of a vehicle, the used brake fluid are extracted from fluid pipelines of brake cylinders of the car, and the new brake fluid are poured into a fluid tank of the brake master cylinder of the car through a fluid feeding device.

A conventional brake fluid feeding device is disclosed. In the disclosure, the brake fluid is fed in a fluid feeder firstly, and then the fluid feeder is hanged at a higher position, so that the brake fluid can be poured into the fluid tank of the brake master cylinder through the fluid pipeline by the gravity. However, because the fluid feeder utilizes the gravity as the driving force for feeding the brake fluid simply, the feeding speed is quite slow, the feeding procedure is time consuming, and the working efficiency for exchanging the brake fluid is insufficient.

Moreover, as shown in FIG. 8, another conventional fluid feeding device is disclosed. In the disclosure, the fluid feeding device includes a cap 92 assembled to a fluid cylinder 91, and the cap 92 has a pressable handle 93, a gas channel 94, a pressure gauge 95, and a safety valve 96. A control valve (not shown) is assembled between the pressable handle 93 and the gas channel 94 for controlling high-pressure gas to enter into the fluid cylinder 91. Accordingly, the high-pressure gas can be continuously fed into the fluid cylinder 91. When the pressure of the fluid cylinder 91 becomes higher and exceeds a certain value, the brake fluid in the fluid cylinder 91 will be pushed by the high-pressure gas, so that the brake fluid can be output from the fluid cylinder 91 to the fluid tank of the brake master cylinder automatically. Although the fluid feeding device can feed the fluid to the car by the pressure difference between the fluid cylinder 91 and the circumstance out of the fluid cylinder 91 in a faster way, the structure of the cap 92 is too complicated. As a result, the fluid feeding device cannot be manufactured and assembled easily. In addition, the fluid cylinder 91 is too heavy and too bulky to be operated conveniently.

### SUMMARY OF THE INVENTION

One object of the present invention is to provide a brake fluid feeding device that has a simple structure and can be manufactured and assembled easily. Therefore, the brake fluid feeding device can be operated easily and conveniently.

Another object of the present invention is to provide a brake fluid feeding device in which the sealing of a fluid container of the device can be checked, so that the gas poured into the fluid container would not leak easily.

To achieve the above and other objects, a brake fluid feeding device comprises a fluid container, a cap, and an inflator. The fluid container has a mouth extending upward. The fluid container has a fluid storing space therein. The fluid storing space communicates with the mouth. The cap is assembled on the mouth to cover the fluid storing space. The cap has a top surface facing upward and a bottom surface opposite to the top surface. The cap has a first hole and a second hole. The first hole and the second hole are defined through the top surface and the bottom surface. The first hole is connected to a gas inlet hose. The gas inlet hose is facing toward the top surface and extending outward. The gas inlet hose has a first end and a second end. The first end is connected to the first hole, and the second end is extending outward. The second hole is connected to a fluid-supplying hose. The fluid-supplying hose is facing toward the top surface and extending outward. The fluid-supplying hose has a head portion and a tail portion. The head portion is connected to the second hole, and the tail portion is extending outward. The inflator has a body. A piston pusher is inserted into one of two ends of the body along the axial direction of the body and the piston pusher is for being pushed and pulled reciprocatingly by a user's hand. The other end of the body comprises a gas-supplying portion. The second end of the gas inlet hose is detachably connected to the gas-supplying portion. When the piston pusher is pushed and pulled reciprocatingly, gas is pushed and output from the gas-supplying portion and further enters the fluid storing space of the fluid container via the gas inlet hose.

In one embodiment, a first positioning member is inserted into the first end of the gas inlet hose. The first positioning member is a hollowed tube and two ends of the first positioning member are opened and in communication with each other. The outer diameter of the first positioning member is greater than the inner diameter of the first end, so that the first end of the gas inlet hose is pushed against the first positioning member and securely positioned in the first hole. A second positioning member is inserted into the head portion of the fluid-supplying hose. The second positioning member has a connecting end and an extending end opposite to the connecting end. The connecting end of the second positioning member is inserted into the head portion of the fluid-supplying hose. The outer diameter of the connecting end is greater than the inner diameter of the head portion, so that the head portion of the fluid-supplying hose is pushed against the connecting end of the second positioning member and securely positioned in the second hole. A fluid suction hose is further connected to the extending end of the second positioning member and extending downward.

Furthermore, the first positioning member has a first cone portion. The first cone portion of the first positioning member is inserted into the first end of the gas inlet hose. The outer diameter of the first cone portion gradually reduces along a direction by which the first cone portion is inserted into the first end. A maximum outer diameter of the first cone portion is greater than the inner diameter of the first end. The first positioning member has a first shoulder portion extending peripherally from a portion of the first cone portion having the maximum outer diameter. The connecting end of the second positioning member has a second cone portion. The second cone portion of the connecting end of the second positioning member is inserted into the head portion of the fluid-supplying hose. The outer diameter of the second cone portion gradually reduces along a direction by which the second cone portion is inserted into the head portion. A maximum outer diameter of the second cone portion is greater than the inner diameter of the head portion. The second positioning member has a second shoulder portion extending peripherally from a portion of the second cone portion having the maximum outer diameter.

In one embodiment, a pressure gauge is assembled on the body of the inflator for checking the inflation pressure. Furthermore, the cap further has a third hole defined through the top surface and the bottom surface, and a pressure relief valve is assembled in the third hole.

In one embodiment, the fluid container further comprises a hanging member at the mouth. The hanging member has a buckling portion in U shaped. One end of the buckling portion is bent to form a hook portion extending upward along the length direction of the mouth and vertically connected to the buckling portion. The buckling portion has an opening for being buckled at the outer periphery of the mouth laterally. The size of the opening is smaller than the diameter of the outer periphery of the cap. When the cap covers the mouth, the buckling portion of the hanging member is pressed downward by the cap and the vertical movement of the hanging member is limited by the cap, and the hook portion of the hanging member is blocked by the outer periphery of the cap, so that the hanging member is not laterally detached from the mouth.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 illustrates an exploded view of a brake fluid feeding device according to an exemplary embodiment of the present invention;

FIG. 2 illustrates an assembled perspective view of the brake fluid feeding device;

FIG. 3 illustrates a sectional assembled view of a cap and a fluid container of the brake fluid feeding device;

FIG. 4 illustrates a schematic perspective view of a hanging member assembled to the brake fluid feeding device;

FIG. 5 illustrates a schematic assembled view showing that the hanging member is assembled to a mouth of the brake fluid feeding device; and

FIG. 6 illustrates a perspective view of a conventional fluid feeding device.

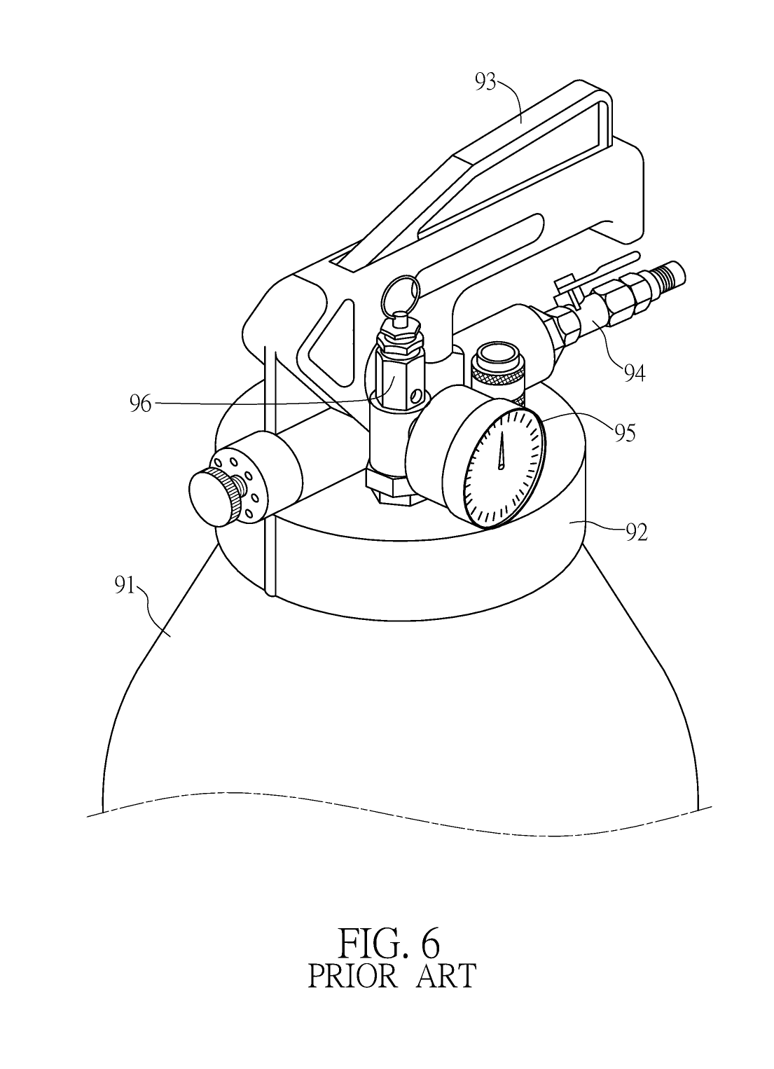

### DETAILED DESCRIPTION OF THE PREFERRED EMBODIMENTS

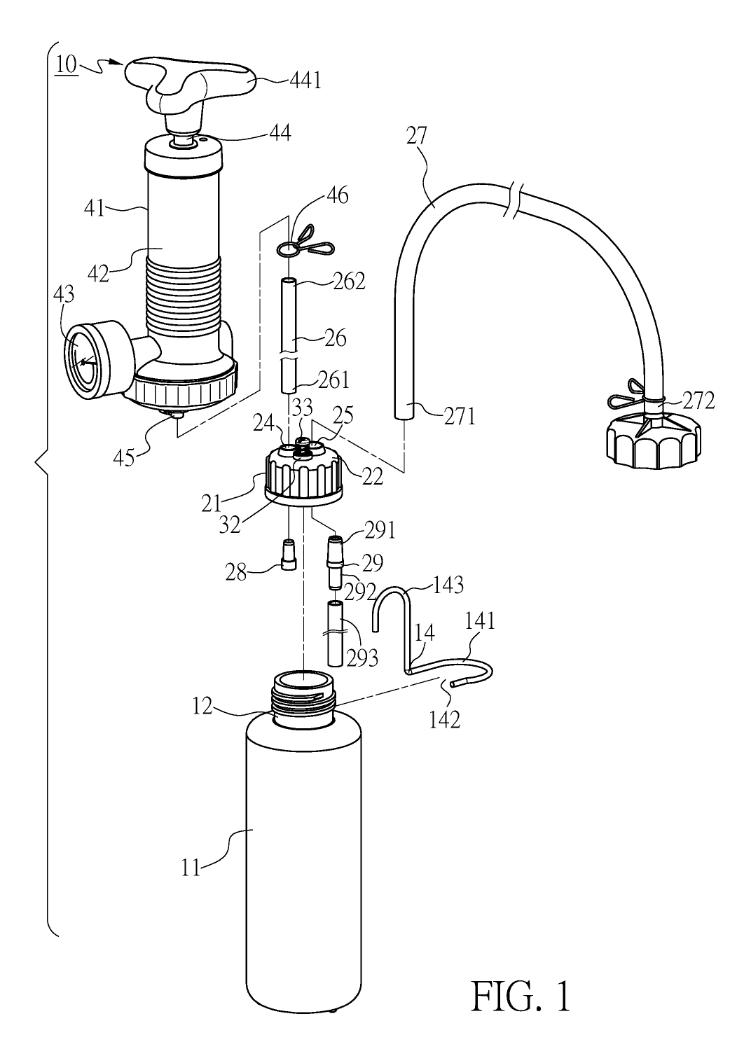

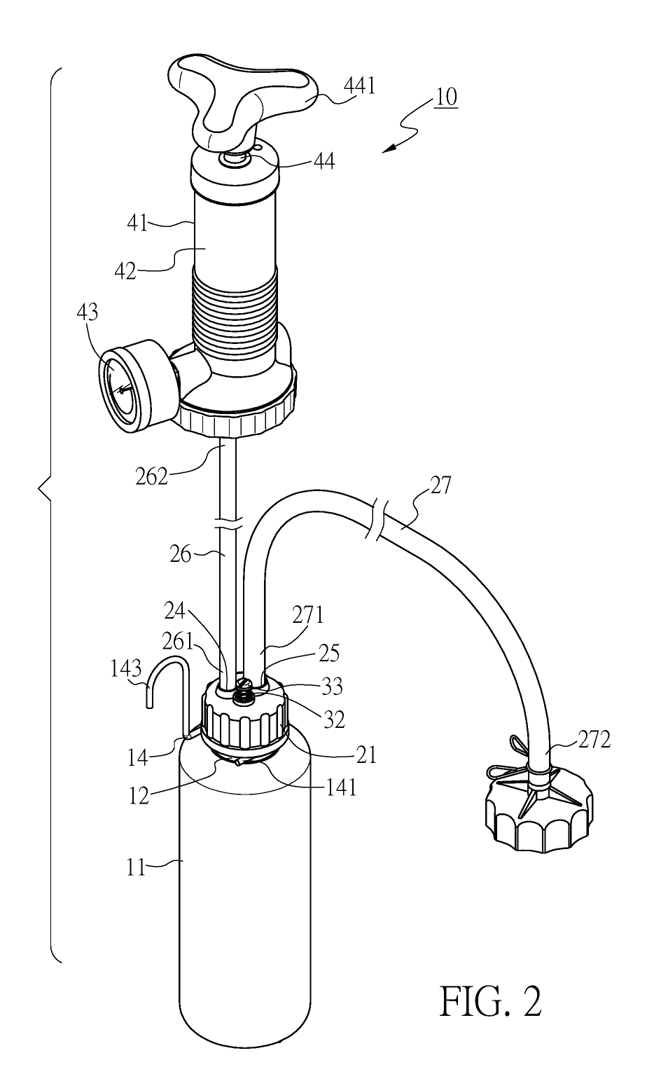

Please refer to FIGS. 1 to 3, which illustrate a brake fluid feeding device 10 according to an exemplary embodiment of the present invention. The brake fluid feeding device 10 comprises a fluid container 11, a cap 21, and an inflator 41.

The fluid container 11 is a hollowed cylinder and has a mouth 12 extending upward. The fluid container 11 has a fluid storing space 13 therein. The fluid storing space 13 communicates with the mouth 12, and the fluid storing space 13 is for the storage of brake fluid. In addition, a hanging member 14 is further assembled to the periphery of the mouth 12 for allowing the fluid container 11 to be hanged.

The cap 21 is assembled on the mouth 12 to cover the fluid storing space 13. The cap 21 has a top surface 22 facing upward and a bottom surface 23 opposite to the top surface 22. The cap 21 has a first hole 24 defined through the top surface 22 and the bottom surface 23. The cap 21 has a second hole 25 defined through the top surface 22 and the bottom surface 23. The first hole 24 is connected to a gas inlet hose 26 facing toward the top surface 22 and extending outward. The gas inlet hose 26 has a first end 261 inserted in the first hole 24 and a second end 262 extending outward. The second hole 25 is connected to a fluid-supplying hose 27 facing toward the top surface 22 and extending outward. The fluid-supplying hose 27 has a head portion 271 inserted in the second hole 25 and a tail portion 272 extending outward. A first positioning member 28 is inserted into the first end 261 of the gas inlet hose 26. The first positioning member 28 is a hollowed tube, and two ends of the first positioning member 28 are opened and in communication with each other. The outer diameter C1 of the first positioning member 28 is greater than the inner diameter D1 of the first end 261, so that the first end 261 of the gas inlet hose 26 is pushed against the first positioning member 28 and securely positioned in the first hole 24. A second positioning member 29 is inserted into the head portion 271 of the fluid-supplying hose 27. The second positioning member 29 has a connecting end 291 and an extending end 292 opposite to the connecting end 291. The connecting end 291 of the second positioning member 29 is inserted into the head portion 271 of the gas-supplying hose 27. The outer diameter C2 of the connecting end 291 is greater than the inner diameter D2 of the head portion 271, so that the head portion 271 of the fluid-supplying hose 27 is pushed against the second positioning member 29 and securely positioned in the second hole 25. The extending end 292 of the second positioning member 29 is connected to a fluid suction hose 293 extending downward. Moreover, the cap 21 has a third hole 32 defined through the top surface 22 and the bottom surface 23, and a pressure relief valve 33 is assembled in the third hole 32.

The inflator 41 has an elongated cylinder body 42 for being held by one hand of a user. The body 42 and the fluid container 11 are separated pieces. A pressure gauge 43 is assembled on the body 42 of the inflator 41 for checking the inflation pressure. A piston pusher 44 is inserted into one of two ends of the body 42 along the axial direction of the body 42, and the other end of the body 42 comprises a gas-supplying portion 45. The piston pusher 44 further comprises a handle portion 441. The handle portion 441 is for being held by other hand of the user. Accordingly, the user uses the other hand to hold the handle portion 441 and pushes and pulls the piston pusher 44 relative to the body 42 along the axial direction of the body 42 reciprocatingly to allow gas to be pushed and output from the gas-supplying portion 45. In addition, the second end 262 of the gas inlet hose 26 is detachably connected to the gas-supplying portion 45. In this embodiment, the gas-supplying portion 45 is a hollowed tube protruded outward, the second end 262 of the gas inlet hose 26 is for fitting over the gas-supplying portion 45, and a ring member 46 is further fitting over the second end 262 of the gas inlet hose 26 and the gas-supplying portion 45 at the same time, so that the second end 262 of the gas inlet hose 26 can be positioned with the gas-supplying portion 45. When the second end 262 of the gas inlet hose 26 is connected to the gas-supplying portion 45, gas output from the gas-supplying portion 45 can enter into the fluid storing space 13 of the fluid container 11 through the gas inlet hose 26. Next, the piston pusher 44 of the inflator 41 is continuously pushed and pulled, so that gas can be continuously poured into the fluid storing space 13 of the fluid container 11. Therefore, a pressure difference is formed between the fluid storing space 13 and the circumstance out of the fluid container 11, and the gas in the fluid storing space 13 then pushes the brake fluid out of the fluid storing space 13 through the gas suction hose 293 and the gas-supplying hose 27, so that the brake fluid can be poured into the brake master cylinder. In addition, when a user uses the inflator 41 to provide gas into the fluid storing space 13, the pressure in the fluid storing space 13 can be immediately monitored from the pressure gauge 43 on the inflator 41. Furthermore, when the pressure in the fluid storing space 13 exceeds a certain value, the user may adjust the pressure in the fluid storing space 13 properly by the pressure relief valve 33 on the cap 21 to prevent the brake fluid pipeline from being damaged by the overvalued pressure applied to the brake fluid pipeline.

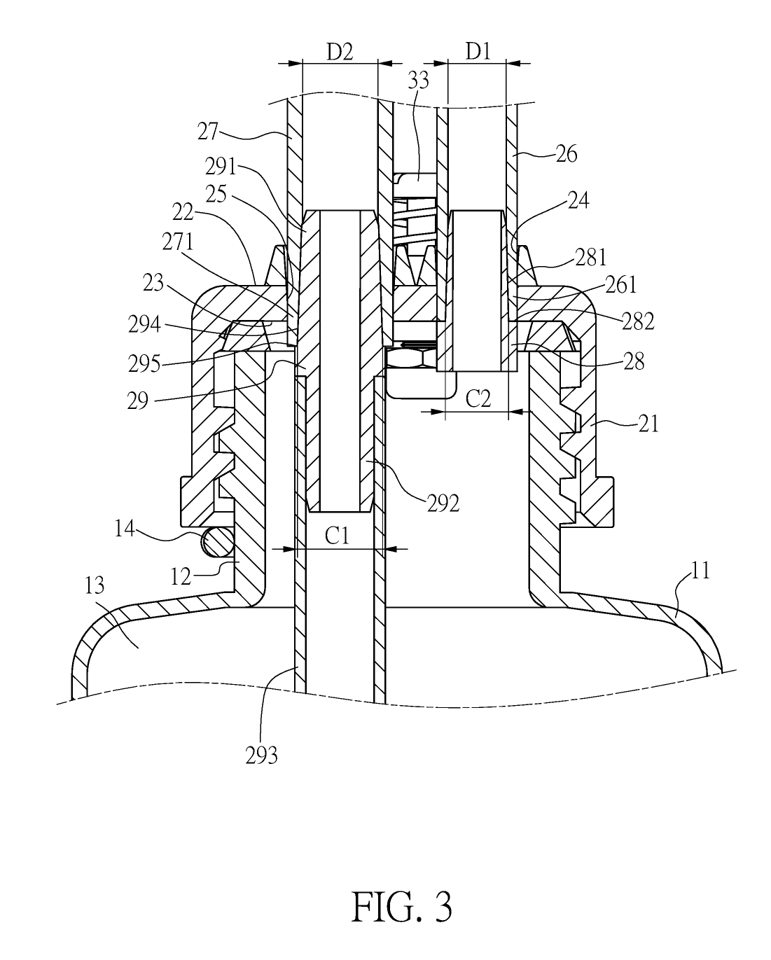

Please further refer to FIG. 3. In this embodiment, the first positioning member 28 has a first cone portion 281, and the first cone portion 281 of the first positioning member 28 is inserted into the first end 261 of the gas inlet hose 26. The outer diameter of the first cone portion 281 gradually reduces along a direction by which the first cone portion 281 is inserted into the first end 261. A maximum outer diameter C1 of the first cone portion 281 is greater than the inner diameter D1 of the first end 261 of the gas inlet hose 26. The first positioning member 28 has a first shoulder portion 282 extending peripherally from a portion of the first cone portion 281 having the maximum outer diameter C1, so that the first cone portion 281 of the first positioning member 28 is inserted into the first end 261 of the gas inlet hose 26. When the end portion of the first end 261 of the gas inlet hose 26 is abutted against the first shoulder portion 282, the first end 261 of the gas inlet hose 26 is pushed against the first cone portion 281 of the first positioning member 28 and securely positioned in the first hole 24. The connecting end 291 of the second positioning member 29 has a second cone portion 294, and the second cone portion 294 of the connecting end 291 of the second positioning member 29 is inserted into the head portion 271 of the fluid-supplying hose 27. The outer diameter of the second cone portion 294 gradually reduces along a direction by which the second cone portion 294 is inserted into the head portion 271. A maximum outer diameter C2 of the second cone portion 294 is greater than the inner diameter D2 of the head portion 271. The second positioning member 29 has a second shoulder portion 295 extending peripherally from a portion of the second cone portion 294 having the maximum outer diameter C2, so that the second cone portion 294 of the second positioning member 29 is inserted into the head portion 271 of the fluid-supplying hose 27. When the end portion of the head portion 271 of the fluid-supplying hose 27 is abutted against the second shoulder portion 295, the head portion 271 of the fluid-supplying hose 27 is pushed against the second cone portion 294 of the second positioning member 29 and securely positioned in the second hole 25.

It is understood that, the gas inlet hose 26 in the first hole 24 and the fluid-supplying hose 27 in the second hole 25 may further be pushed by the first cone portion 281 of the first positioning member 28 and the second cone portion 294 of the second positioning member 29 respectively, so that the gas inlet hose 26 is securely in contact with the inner wall of the first hole 24 and the fluid-supplying hose 27 is securely in contact with the inner wall of the second hole 25, and the first hole 24 and the second hole 25 are accordingly sealed. Consequently, the first positioning member 28 and the second positioning member 29 are not only for positioning the gas inlet hose 26 and the fluid-supplying hose 27, but also for deforming the gas inlet hose 26 and the fluid-supplying hose 27 by compressing the gas inlet hose 26 and the fluid-supplying hose 27, so that the first hole 24 and the second hole 25 can be respectively securely sealed by the gas inlet hose 26 and the fluid-supplying hose 27, and the gas poured into the fluid storing space 13 by the inflator 41 would not leak out of the fluid storing space 13 easily.

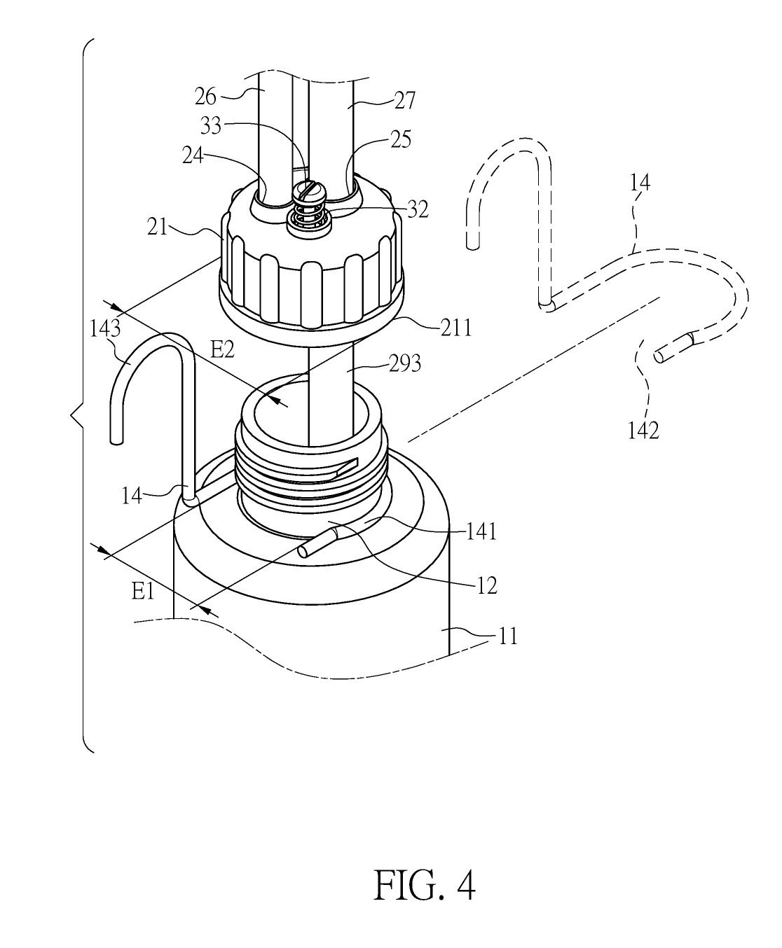

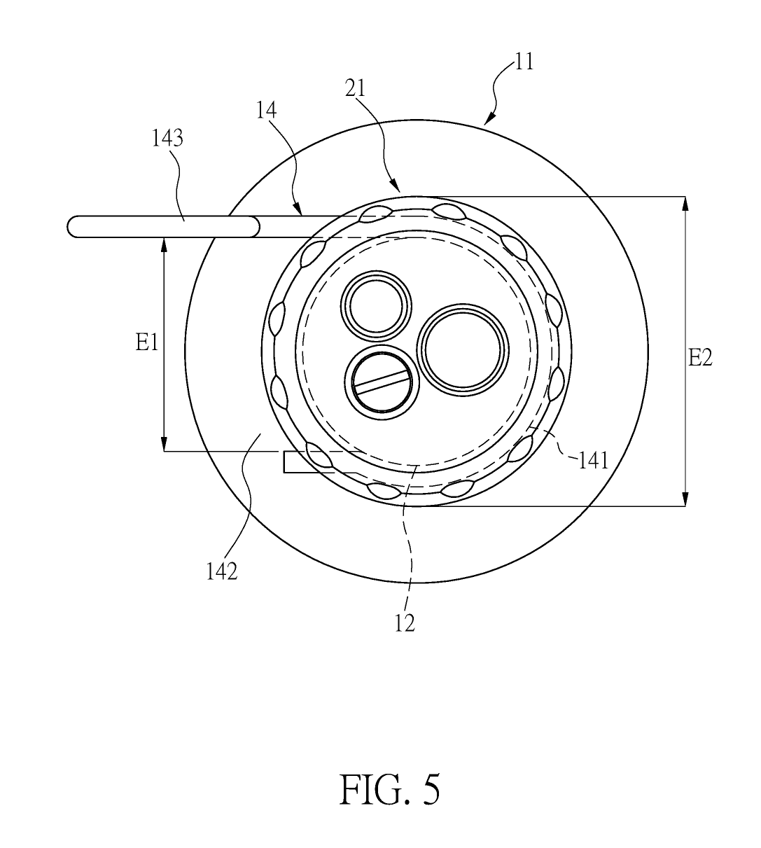

Furthermore, as shown in FIG. 4, in this embodiment, the hanging member 14 has a buckling portion 141 in U shaped. One end of the buckling portion 141 is bent to form a hook portion 143 extending upward along the length direction of the mouth 12 and vertically connected to the buckling portion 141. The buckling portion 141 has an opening 142 for being buckled at the outer periphery of the mouth 12 laterally. The size E1 of the opening 142 is smaller than the diameter E2 of the outer periphery of the cap 21. Therefore, when the cap 21 covers the mouth 12, as shown in FIGS. 4 and 5, the buckling portion 141 of the hanging member 14 is pressed downward by the cap 21 and the vertical movement of the hanging member 14 is limited by the cap 21, and the hook portion 143 of the hanging member 14 is blocked by the outer periphery of the cap 21, so that the hanging member 14 is not laterally detached from the mouth 12. Therefore, the hanging member 14 can detach from the mouth 12 from neither the vertical direction nor the lateral direction of the mouth 12. Consequently, when the fluid container 11 is hanged, for example, at a higher portion of a wall by the hanging member 14, the fluid container 11 can be hanged stably and safely.

As above, the fluid container 11 and the inflator 41 of the brake fluid feeding device 10 are separated pieces, and the fluid container 11 and the inflator 41 are respectively connected to the fluid-supplying hose 27 and the gas inlet hose 26 in a detachable manner, so that the brake fluid feeding device 10 according to the present invention can be assembled and repaired easily. In addition, the structure of the cap 21 is simple; the cap 21 has the first hole 24 and the second hole 25 for mating with the first positioning member 28 and the second positioning member 29, and the gas inlet hose 26 and the fluid-supplying hose 27 can be positioned in the first hole 24 and the second hole 25 of the cap 21, respectively. Accordingly, the brake fluid feeding device 10 can be manufactured easily and can be operated conveniently. The user can operate the inflator 41 directly to pour gas into the fluid storing space 13 without any pressurization equipment. In addition, the first positioning member 28 and the second positioning member 29 can be further provided for sealing the first hole 24 and the second hole 25, so that the fluid storing space 13 can be sealed, and the gas input into the fluid storing space 13 would not leak easily.

Furthermore, because the brake fluid feeding device 10 further comprises the hanging member 14 buckled on the mouth 12 of the fluid container 11, a user can optionally place the fluid container 11 on the ground or on an article, or the user can hang the fluid container 11 on a wall based on the operation condition. Moreover, because the fluid container 11 and the inflator 41 are separated pieces, the brake fluid feeding device 10 according to the present invention can be operated conveniently in a small operating space.

What is claimed is:

1. A brake fluid feeding device, comprising:
a fluid container, having a mouth extending upward, wherein the fluid container has a fluid storing space therein, and the fluid storing space communicates with the mouth;
a cap assembled on the mouth to cover the fluid storing space, wherein the cap has a top surface facing upward and a bottom surface opposite to the top surface, and the cap has a first hole and a second hole, the first hole and the second hole are defined through the top surface and the bottom surface, wherein a first positioning member is in the first hole and connected to a gas inlet hose, the gas inlet hose is facing toward the top surface and extending outward, wherein the gas inlet hose has a first end and a second end, the first end is connected to the first positioning member, and the second end is extending outward, wherein a second positioning member is in the second hole and one of two ends of the second positioning member is connected to a fluid-supplying hose, the fluid-supplying hose is facing toward the top surface and extending outward, wherein the fluid-supplying hose has a head portion and a tail portion, the head portion is connected to the second positioning member, and the tail portion is extending outward, the other end of the second positioning member is connected to a fluid suction hose, the fluid suction hose is extending downward;
an inflator having a body for being held by one hand of a user, wherein the body and the fluid container are separated pieces, wherein a piston pusher is inserted into one of two ends of the body along the axial direction of the body and the piston pusher is for being pushed and pulled reciprocatingly by the other hand of the user, wherein the other end of the body comprises a gas-supplying portion, the second end of the gas inlet hose is detachably connected to the gas-supplying portion, wherein when the piston pusher is pushed and pulled reciprocatingly, gas is pushed and output from the gas-supplying portion and further enters the fluid storing space of the fluid container via the gas inlet hose.

2. The brake fluid feeding device according to claim 1, wherein the first positioning member is inserted into the first end of the gas inlet hose, the first positioning member is a hollowed tube and two ends of the first positioning member are opened and in communication with each other, the outer diameter of the first positioning member is greater than the inner diameter of the first end, so that the first end of the gas inlet hose is pushed against the first positioning member and securely positioned in the first hole, and wherein the second positioning member has a connecting end and an extending end opposite to the connecting end, the connecting end of the second positioning member is inserted into the head portion of the fluid-supplying hose, the outer diameter of the connecting end is greater than the inner diameter of the head portion, so that the head portion of the fluid-supplying hose is pushed against the connecting end and securely positioned in the second hole, and the extending end is connected to the fluid suction hose.

3. The brake fluid feeding device according to claim 2, wherein the first positioning member has a first cone portion, the first cone portion of the first positioning member is inserted into the first end of the gas inlet hose, the outer diameter of the first cone portion gradually reduces along a direction by which the first cone portion is inserted into the first end, a maximum outer diameter of the first cone portion is greater than the inner diameter of the first end, the first positioning member has a first shoulder portion extending peripherally from a portion of the first cone portion having the maximum outer diameter.

4. The brake fluid feeding device according to claim 2, wherein the connecting end of the second positioning member has a second cone portion, the second cone portion of the connecting end of the second positioning member is inserted into the head portion of the fluid-supplying hose, the outer diameter of the second cone portion gradually reduces along a direction by which the second cone portion is inserted into the head portion, a maximum outer diameter of the second cone portion is greater than the inner diameter of the head portion, the second positioning member has a second shoulder portion extending peripherally from a portion of the second cone portion having the maximum outer diameter.

5. The brake fluid feeding device according to claim 1, wherein a pressure gauge is assembled on the body of the inflator for checking the inflation pressure.

6. The brake fluid feeding device according to claim 5, wherein the cap further has a third hole defined through the top surface and the bottom surface, and a pressure relief valve is assembled in the third hole.

7. The brake fluid feeding device according to claim 1, wherein the fluid container further comprises a hanging member at the mouth, the hanging member has a buckling portion in U shaped, one end of the buckling portion is bent to form a hook portion extending upward along the length direction of the mouth and vertically connected to the buckling portion, the buckling portion has an opening for being buckled at the outer periphery of the mouth laterally, wherein the size of the opening is smaller than the diameter of the outer periphery of the cap, and wherein when the cap covers the mouth, the buckling portion of the hanging member is pressed downward by the cap and the vertical movement of the hanging member is limited by the cap, and the hook portion of the hanging member is blocked by the outer periphery of the cap, so that the hanging member is not laterally detached from the mouth.
